(19) United States
(12) Patent Application Publication
(10) Pub. No.: US 2011/0299085 A1
(43) Pub. Date: Dec. 8, 2011

(54) Rapid Tissue Analysis Technique

(75) Inventors: Michael John Preiner, Palo Alto, CA (US); Nicholas Carleton Koshnick, Palo Alto, CA (US); Justin Stewart White, Palo Alto, CA (US)

(73) Assignee: SOLUM, INC., Mountain View, CA (US)

(21) Appl. No.: 13/152,843

(22) Filed: Jun. 3, 2011

Related U.S. Application Data
(60) Provisional application No. 61/351,786, filed on Jun. 4, 2010.

(51) Int. Cl. G01N 21/59

(52) U.S. Cl. 356/436

(57) ABSTRACT

A tissue measurement device can provide for rapid, robust analysis of large volumes of plant tissue samples in the field. The tissue measurement device measures tissue samples in a liquid state. The tissue measurement device uses a spectrometer to determine an absorbance spectrum over a range of wavelengths. The absorbance spectrum provides information about the properties of the tissue sample. Tissue samples may be mixed with various extractants or reagents to further improve the accuracy of measurements or allow measurement of a wider variety of nutrients or properties. The tissue measurement device may also take calibration measurements to improve the measurement of tissue sample properties.

### CROSS REFERENCE TO RELATED APPLICATION

This application claims priority under 35 U.S.C. §119(e) from provisional Application Ser. No. 61/351,786, filed on Jun. 4, 2010, which is incorporated by reference herein.

### FIELD OF THE INVENTION

The present invention relates generally to agriculture and nutrition management, and more particularly to the measurement of plant tissue properties.

### BACKGROUND OF THE INVENTION

Farmers often make soil nutrient management decisions based on plant tissue sample test results. Particularly, petiole testing is viewed as an important nutrient management tool. These plant samples are often collected by agronomists or service providers and are then sent to plant and soil chemistry labs for the analysis. The most common technique for measuring properties of tissue samples involves using ion-selective electrodes, which have limited lifespan and are subject to interference.

Further, tissue measurements cannot be practically performed in the field, which means that tissue samples must be stored and transported. This increases the amount of time required to perform a tissue sample analysis. Further, the added time between when the sample is taken and when the sample is measured can result in degradation of the sample prior to measurement. As a result of these factors, tissue sample analysis is a time intensive and costly endeavor, producing a result that varies widely in quality.

### BRIEF SUMMARY

A tissue measurement device can provide for rapid, robust analysis of large volumes of plant tissue samples in the field. The tissue measurement device measures tissue samples in a liquid state. The tissue measurement device uses a spectrometer to determine an absorbance spectrum over a range of wavelengths. The absorbance spectrum provides information about the properties of the tissue sample.

In various embodiments, the tissue measurement device can measure concentrations of various nutrients, including for example nitrate-nitrogen, phosphorus, potassium, and sulfur. Various embodiments can also measure other properties, such as pH, moisture, and conductivity. In the example of nitrate, the tissue measurement device uses the 200 nanometer (nm) and/or 300 nm absorbance bands of nitrate to determine the nitrate-nitrogen concentration in the tissue sample.

Tissue samples may be mixed with various extractants or reagents to further improve the accuracy of measurements or allow measurement of a wider variety of nutrients or properties. The tissue measurement device may also take calibration measurements to improve the measurement of tissue sample properties.

### BRIEF DESCRIPTION OF THE DRAWINGS

FIG. 1 is a block diagram of an example tissue measurement device in accordance with one embodiment.

FIG. 2 is a flowchart illustrating a process for determining properties of a tissue sample, in accordance with one embodiment.

FIG. 3 illustrates an absorbance spectrum captured by a tissue measurement device.

FIG. 4 illustrates a reference spectrum captured by a tissue measurement device.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF PREFERRED EMBODIMENTS

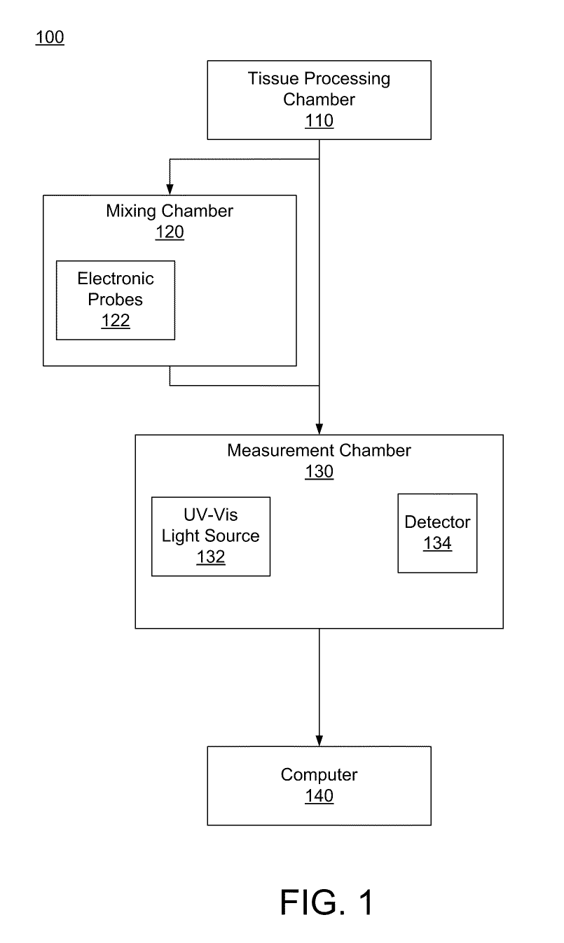

FIG. 1 is an example embodiment of a tissue measurement device 100 in accordance with one embodiment. The device includes a tissue processing chamber 110, a mixing chamber 120, a measurement chamber (e.g., an optical absorbance cell) 130, and a computer or other type of processor 140. The tissue processing chamber, the mixing chamber, and the measurement chamber are designed to hold liquids, and thus the tissue measurement device typically also includes barriers (e.g., valves) and transmission mechanisms (e.g., tubes) for transporting liquids between the chambers of the device.

The tissue processing chamber 110 includes an intake to receive the tissue sample to be analyzed. The tissue sample may include, for example, petioles, leaves, stalks, and roots, taken from a plant of interest. A wide variety of plants may be of interest including, for example, peppers, tomato, cantaloupe, watermelon, broccoli, cauliflower, lettuce, cabbage, onions, and corn. The tissue sample may be taken from any kind of plant. The tissue processing chamber 110 extracts and collects the liquid contained within the tissue. The extracted liquid or sap is referred to as the “tissue liquid.” In one approach, the tissue processing chamber 110 extracts the tissue liquid by crushing (or pressing) samples. Extraction could also be performed by blending the samples with liquid, ultrasonic processing, or several other techniques. The tissue liquid may be collected via gravity, pressure, suction, or other mechanisms.

In some cases, the tissue sample is dry when it is received, for example stalks of corn to be tested may be dry when they are received for testing. In order to prepare dry tissue samples to extract tissue liquid, dry tissue samples may be mixed with water prior to extracting the tissue liquid. In another approach, tissue liquid can be obtained indirectly, for example by collecting drainage water that has run off from a field of plants of interest. The tissue liquid may be collected by filtering and separating the tissue liquid from collected drainage water.

The collected tissue liquid is transferred to either a mixing chamber 120, or alternately directly into the measurement chamber 130. The mixing chamber 120 mixes the tissue liquid with other liquid(s) to produce a solution. Non-tissue liquids include, for example, water (including deionized water or ordinary tap water), extractants, and/or reagents. Non-tissue liquids may be added manually or automatically to the mixing chamber 120. Non-tissue liquids may be added to a tissue liquid for various reasons, for example to improve the ability of the measurement chamber 130 to measure the properties of the tissue sample. In some cases, the addition of reagents in the mixing chamber, and therefore into the solution, allows the measurement of additional properties of the tissue sample that cannot be measured with just the tissue liquid alone. The outlet of the mixing chamber 120 connects to the measurement chamber 130.

In one design, the mixing chamber 120 includes electronic probes 122 to perform measurements on the contents of the mixing chamber. Examples of electronic probes include a conductivity probe, a pH electrode, or a nitrate ion selective electrode. Measurements performed by the electronic probes 122 may also be performed in duplicate through the addition and measurement of reagents, for example a pH test performed by a pH electrode 122 may also be performed by adding and measuring phenol red indicator to the tissue liquid.

The addition of water and/or extractants is not required in all cases. In some cases, tissue liquid from the tissue processing chamber 110 is directly measured in the measurement chamber 130. In these cases, the solution is 100% tissue liquid, and the two terms become interchangeable.

The mixing chamber 120 combines the tissue liquid and additional non-tissue liquids by stirring, shaking, blending, sonication, or any other technique that homogenizes the contents of the solution. In one design, the mixing chamber includes a bladed propeller and a turbulator for mixing the solution. A filter can also be used to filter the solution, if so desired.

The solution created by the mixing chamber 120 has a dilution ratio defined by the amount of tissue liquid in the solution and the amount of any non-tissue liquids in the solution. In one approach, the weight and/or volume of the tissue liquid or tissue sample is known. The amount of non-tissue liquid to be added can be determined based on the weight and/or volume of the tissue liquid or tissue sample, and the desired dilution ratio. Typically, the dilution ratio is set so as not overwhelm the absorbance range of the measurement chamber 130 at the desired wavelength(s) to be measured, and will typically range from no non-tissue liquid to 1 part part tissue liquid to 10,000 parts non-tissue liquid, by weight or by volume.

In a related approach, the dilution ratio is achieved by using a collection cup (not shown) of a fixed size to add non-tissue liquids. The collection cup may be affixed to or removable from the tissue measurement device 100. The collection cup is sized to produce the desired dilution ratio, and thus will depend on the amount of tissue liquid present in each tissue sample.

At least some of the solution is permitted to travel from the mixing chamber 120, or alternatively the tissue processing chamber 110, to the measurement chamber 130. In the measurement chamber 130, a spectrometer determines an absorbance (or extinction) spectrum associated with the solution. The spectrometer may also perform calibration measurements to obtain reference spectra, to assist in calibrating the absorbance spectrum measurement. The absorbance spectrum may be determined continuously or at periodic time intervals. Characteristics of the absorbance spectrum are analyzed to identify properties of the tissue liquid and/or the tissue sample.

The spectrometer of the measurement chamber includes a detector 134 and an ultraviolet (UV)-visible light source 132. In this example, the UV-visible light source has a wavelength bandwidth including at least the wavelengths between 190 nm to 850 nm, or alternately at least between 180 nm to 220 nm, 200 nm to 220 nm, or at least between 280 nm to 320 nm. In one embodiment, the light source 132 is a Heraeus UV-Vis FiberLight (model DTM 6/50S).

The absorbance spectrum may be used to determine different properties of the plant tissue including, for example, nutrient concentrations (such as nitrate-nitrogen, phosphorus, potassium, sulfur, zinc, iron, manganese, organic matter content such as humic acid, and amino acid nitrogen) and other plant properties (such as pH, moisture, particulate size, and conductivity). Additional properties of the tissue sample may also be determined from the absorbance spectrum by adding reagents to the solution.

In one case the measurement chamber 130 includes an infrared (IR) light source (not shown). The IR light source emits light in at least the infrared electromagnetic spectrum if not also the visible spectrum. The IR light source may be used to perform a reflectance measurement on the tissue liquid. In this approach, the IR light source is positioned relative to the detector 134 so that the detector receives light reflected from the tissue liquid.

The measurement chamber 130 may also make calibration measurements. One type of calibration measurement measures a reference spectrum for only the non-tissue liquids. The non-tissue liquids can be measured by adding the non-tissue liquid to the measurement chamber 130 prior to adding the tissue liquid. It may be useful to adjust the amount of non-tissue liquid to compensate for any amount lost in the calibration measurement. The reference spectrum for this measurement provides counts water, the amount of absorbance measured by the detector 134 at each wavelength when the light source 132 is activated in the measurement chamber 130, and only non-tissue liquids from the solution are present.

Another possible calibration measurement measures a reference spectrum for the detector of the spectrometer, without any light from the light source reaching the detector. This may be accomplished by adding a shutter somewhere between the light source and the detector, to prevent light from reaching the detector during the measurement. This calibration measurement may be made independent of the liquid contents of the measurement chamber 130. The reference spectrum for this measurement provides counts dark, the amount of absorbance measured by the detector 134 at each wavelength when light from the light source 132 is not present. This reference spectrum account for the non-zero offset of counts from the detector 134.

The measurement chamber 130 may also include an outlet (e.g., an exit valve) for purging the liquid contents of the measurement chamber. U.S. patent application Ser. No. 12/775,418 and U.S. patent application Ser. No. 12/775,762, which are incorporated by reference herein in their entirety, provide additional details of example measurement chambers 130 and mixing chambers 120.

The measurement chamber 130 communicates with a computer 140. The computer 140 analyzes data from the measurement chamber 130 and the electronic probes 122, including the data from the detector 134 as well as any data collected from the other parts of the tissue measurement device 100. The computer 140 may receive data from the measurement chamber 130 in either an optical or electrical format. The computer 140 analyzes spectral data received from the detector 134 and outputs information regarding the properties of the tissue sample.

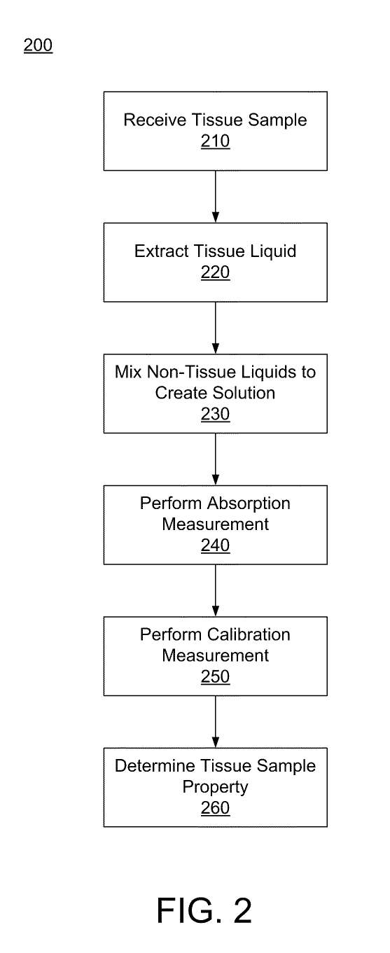

FIG. 2 is a flowchart illustrating a process for using a tissue measurement device 100. A tissue sample, for example a petiole, is received 210 in the tissue processing chamber 110. The tissue processing chamber 110 extracts 220 tissue liquid and transfers the tissue liquid to the mixing chamber. Optionally, the tissue liquid is mixed 230 with water and/or additional extractants to form a solution. The mixing chamber 120 mixes 230 the solution so that the solution is sufficiently homogenous. In one embodiment, the contents of the mixing chamber 120 are also filtered.

In one implementation, the tissue sample is inserted into the tissue processing chamber 110 before any non-tissue liquids are added. In another aspect, non-tissue liquids are inserted into mixing chamber 120 before the tissue liquid is added. In another approach, the tissue sample, and water and/or one or more extractants are inserted into the device 100 simultaneously or nearly simultaneously.

In one embodiment, the tissue liquid is taken 220 from the tissue samples in the field, separate from the tissue measurement device 100. It is then bottled or stored as a liquid prior to transport. Transport of the tissue sample in liquid form, as opposed to transporting the tissue sample itself, reduces degradation of the tissue liquid. The tissue liquids are transported to the tissue measurement device 100 (e.g., a laboratory located remotely from the field where the sample was taken), and are then mixed 230 into solution there.

In the measurement chamber 130, an optical absorbance measurement is performed 240 on the solution. The absorbance due to specific tissue properties (e.g., nutrients such as nitrate) can be determined and correlated to the properties of the tissue sample. Additional calibration measurements may be performed 250 without the tissue liquid. The calibration measurements may be performed 250 before or after the measurement 240 of the tissue liquid.

The absorbance spectrum for the solution is determined by activating the light source 132 and measuring 250 the absorbance of the solution via the detector 134. One definition of the absorbance spectrum is −log₁₀((counts tissue−counts dark)/(counts water−counts dark)), where counts tissue is the number of counts measured on the detector 134 with the tissue liquid in place. The conductivity of the tissue liquid may also be measured to provide an additional point of reference.

The properties of the tissue sample are determined 260 from the absorbance spectrum. The nitrate concentration in the tissue sample may be determined by decomposing the absorbance spectrum into a component from the nitrate-nitrogen in the tissue liquid, and a background signal from the other matter in the tissue liquid. Preferably, the nitrate-nitrogen concentration in the tissue liquid is determined based on the nitrate-nitrogen absorbance peak centered at a wavelength of 200 nm, with a width of approximately 10 nm. The nitrate-nitrogen absorbance peak centered at 300 nm may also be used, especially if this peak can be sufficiently distinguished from the background.

In one approach, the nitrate-nitrogen concentration is determined by fitting the absorbance spectrum to a physical model. One physical model is a Gaussian peak centered at 200 nm for the nitrate component, a Gaussian peak centered at 250 nm for organic carbon, and a background component. The background component may include a term for Rayleigh scattering, a broader Gaussian, and a simple linear term. Tissue conductivity may be used as an additional parameter for determining the nitrate-nitrogen concentration.

In another approach, the nitrate-nitrogen concentration is determined from the absorbance spectrum using a training algorithm, where the training sets are measured absorbance spectra for known amounts of nitrate. In one trial, using a training algorithm the nitrate-nitrogen concentration can be determined to within a 3.5 ppm accuracy using a partial least square regression. As above, tissue conductivity may be used as an additional parameter for the training sets.

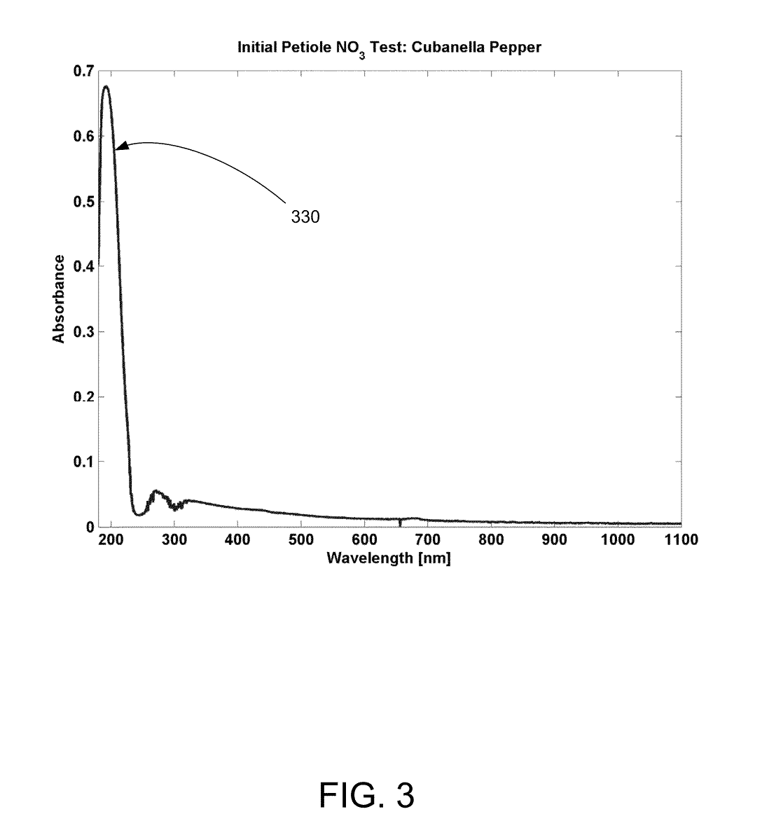

FIG. 3 illustrates an absorbance spectrum captured by a tissue measurement device 100. FIG. 3 plots the amount of absorbance (in arbitrary units), calculated based on measurements from the measurement chamber 130, as a function of the wavelength in nm. In this example, the absorbance spectrum measurement is for a solution with a dilution ratio of one part tissue liquid to thirty five parts water (1:35). The tissue sample is a petiole of Cubanello peppers. The absorbance spectrum clearly shows the 200 nm absorbance band 330 from nitrate.

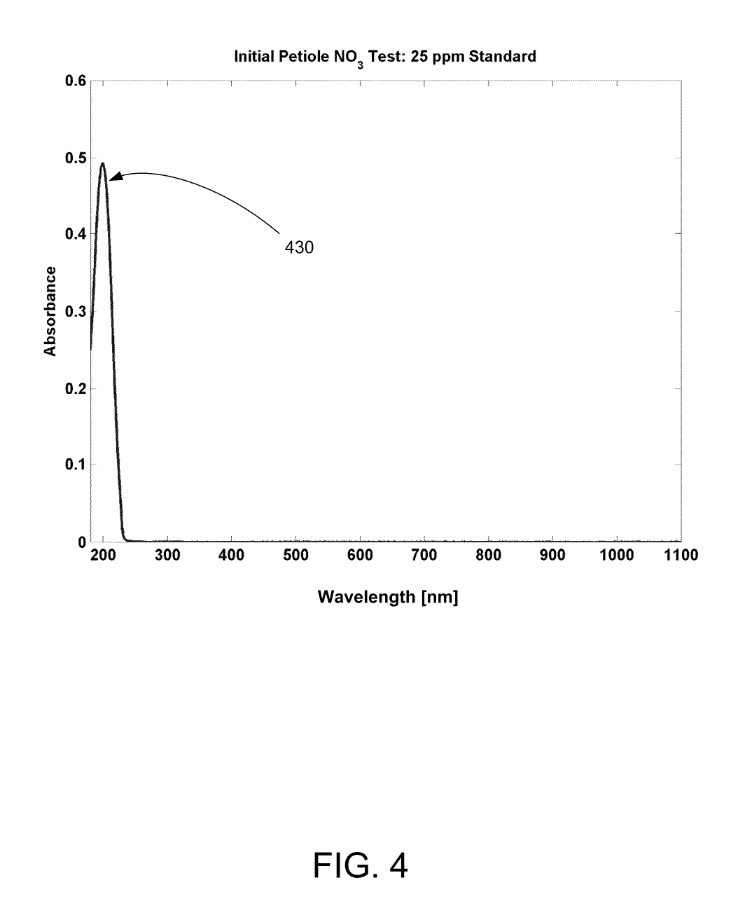

FIG. 4 illustrates a corresponding reference spectrum captured by a tissue measurement device 100, using the same axes as FIG. 3. The calibration measurement has been performed on the non-tissue liquids of the solution. The reference spectrum in FIG. 4 shows the 200 nm absorbance band 430 from nitrate. It is known that the non-tissue liquids have a concentration of 25 ppm of NO₃. The known concentration, together with the data from the 200 nm nitrate absorbance band, may form the basis for a calibration factor establishing that a concentration of 25 ppm equals an absorbance of 0.5.

This calibration factor may be used to assist in the determination of the NO₃—N concentration in a tissue sample. Combining the 200 nm absorbance band from FIG. 3 with the calibration measurement of FIG. 4 yields that the petiole sample has a nitrate-nitrogen (or NO₃—N) concentration of approximately 1200 ppm, which matches well with the expected level of NO₃—N in Cubanello peppers.

Measuring tissue sample properties as described significantly decreases both the time and cost of plant tissue analysis. Measuring tissue properties using the tissue measurement device described herein provides a more robust mechanism than other existing techniques. Analyzing tissue properties in liquid form reduces variability in measurements due to tissue degradation. Tissue samples may be collected and processed in field, and then transported with less degradation to the sample. The tissue measurement device is capable of analyzing a sample in a matter of minutes or seconds, meaning that many measurements of many different tissue samples may be completed in a short period of time.

1. A method of measuring a property of a tissue sample comprising:
mixing a tissue liquid with at least one non-tissue liquid to produce a solution, the tissue liquid originating from the tissue sample;
illuminating the solution with an ultraviolet-visible light source;
measuring an absorbance spectrum of the solution with a detector; and
determining the property of the tissue sample based on the absorbance spectrum of the solution.

2. The method of claim 1 comprising:
receiving a tissue sample; and
processing a tissue sample to produce a tissue liquid.

3. The method of claim 1 comprising filtering the solution prior to measurement.

4. The method of claim 1 comprising measuring the conductivity of the solution.

5. The method of claim 1 wherein measuring the absorbance spectrum comprises measuring a bandwidth range between at least 200 nm to 850 nm

6. The method of claim 1 wherein measuring the absorbance spectrum comprises measuring a bandwidth range between at least 190 nm to 220 nm.

7. The method of claim 1 wherein measuring the absorbance spectrum comprises measuring a bandwidth range between at least 200 nm to 220 nm.

8. The method of claim 1 comprising:
measuring at least one reference spectrum; and
determining the property of the tissue sample based on the absorbance spectrum and the at least one reference spectrum.

9. The method of claim 8 wherein measuring at least one reference spectrum comprises:
illuminating the at least one non-tissue liquid with the ultraviolet-visible light source; and
measuring a reference spectrum of the at least one non-tissue liquid with the detector.

10. The method of claim 8 comprising:
measuring a reference spectrum of the detector in isolation from the light source.

11. The method of claim 1 comprising:
measuring a plurality of reference spectra; and
determining the property of the tissue sample based on the absorbance spectrum and the reference spectra.

12. The method of claim 1, wherein the at least one non-tissue liquids comprise water.

13. The method of claim 1 wherein solution comprises a dilution ratio in the range between one part water with one part tissue liquid, and 10,000 parts water to one part tissue liquid.

14. The method of claim 1 wherein the property of the tissue sample is the nitrate-nitrogen concentration in the tissue sample.

15. The method of claim 14 wherein determining the nitrate-nitrogen concentration of the tissue sample based on the absorbance spectrum comprises analyzing the 200 nm peak of the absorbance spectrum.

16. The method of claim 14 wherein determining the nitrate-nitrogen concentration of the tissue sample based on the absorbance spectrum comprises analyzing the 300 nm peak of the absorbance spectrum.

17. The method of claim 14 wherein determining the nitrate-nitrogen concentration of the tissue sample based on the absorbance spectrum comprises analyzing the absorbance spectrum with a training algorithm.

18. The method of claim 14 wherein determining the nitrate-nitrogen concentration of the tissue sample based on the absorbance spectrum comprises analyzing the absorbance spectrum with a physical model.

19. A method of measuring a property of a tissue sample comprising:
receiving a tissue liquid originating from the tissue sample;
illuminating the tissue liquid with an ultraviolet-visible light source;
measuring an absorbance spectrum of the tissue liquid with a detector; and
determining the property of the tissue sample based on the absorbance spectrum of the solution.

20. A tissue measurement device for measuring a property of a tissue sample comprising:
a mixing chamber configured to receive a tissue liquid and at least one non-tissue liquid, the tissue liquid originating from the tissue sample, the mixing chamber configured to mix the tissue liquid and the at least one non-tissue liquid to produce a solution;
a measurement chamber comprising a ultraviolet-visible light source, and a detector, the measurement chamber configured to receive the solution, to perform a spectroscopic measurement, and to output an absorbance spectrum from the detector;
a computer configured to receive the absorbance spectrum and to output the property of the tissue sample.
